(19) United States
(12) Patent Application Publication
(10) Pub. No.: US 2005/0220971 A1
(43) Pub. Date: Oct. 6, 2005

(54) Process for making non-emulsified, spiced or flavored peanut butters and peanut butter spreads, with lower fat content, long shelf life, and minimal oil separation

(76) Inventor: Katalin Coburn, Agoura Hills, CA (US)

Correspondence Address: MARIE QUASHNOCK, 96 JESSIE ST., SAN FRANCISCO, CA, 94105, US

(21) Appl. No.: 10/814,219

(22) Filed: Apr. 1, 2004

(51) Int. Cl. A23L 1/38

(52) U.S. Cl. 426/633

(57) ABSTRACT

Peanut butters and peanut butters spreads with lower fat content, minimal oil separation, long shelf life and having desired sensory, textural and flavor characteristics are produced by a process including steps of (a) roasting peanuts to a specific degree and color; (b) grinding the roasted, unblanched peanuts to a particle size ranging from 1.5 to 3.5 mm; (c) if desired, adding specific herbs, spices, dried fruits and/or extracts of same, together with salt and/or sugar to the thus obtained peanut paste and blending all components at specific temperatures; (d) pumping the resultant peanut butter through specific pumping systems to depositors; (e) feeding into containers and sealing.

This application claims the benefits to U.S. Provisional Application No. 60/459,018.

### BACKGROUND OF THE INVENTION

1. Technical Field

This invention relates to a process for the production of peanut butter. More particularly, the invention relates to the production of spiced and/or flavored peanut butters and peanut butter spreads with a desired texture, lower fat content, good spreadability, long shelf life and minimal oil separation.

2. Description of the Prior Art

Peanut butter is a paste made from ground roasted peanuts. Because of its good taste, high nutritional value, and low cost, it becomes one of the most popular foods in American households.

The emergence of an educated and highly selective consuming public affects all food choices made. There is an increasing pressure on purveyors and manufacturers of all foods to bring to market earth friendly, pesticide free, organically grown and/or naturally prepared foods, with lower fat content and healthy attributes, but without the sacrifice of flavor and eating pleasure.

The concern with obesity and an aging US population are further propelling the drive toward healthier foods. Contrary to popular belief, it is not children, but adults, who consume the largest percentage of peanut butter in the US; their preferences, however, are similar to those of children. Therefore, a soft and spreadable product is highly desirable for use in both eating and cooking, and the high fat content and oil separation in non-emulsified peanut butters remains a deterrent for many adults.

New methods of production, especially directed at improving composition, taste, texture and appearance are continually sought. Methods for making peanut butter are described in the patent literature.

U.S. Pat. No. 2,079,288 disclosed a method of preparing nut butter to minimize gravitational separation of the ingredients thereof, which comprises grinding peanut kernels alone to the form of a paste or butter, then adding to the peanut butter, while the latter is at the temperature of grinding, quantities of an edible oil and strained bees' honey each heated to approximately 160° F., and thoroughly mixing the ingredients, the added oil and honey when added to the peanut butter possessing approximately the same temperature of the peanut butter immediately following discharge of the latter from the grinding or reduction zone in which it was produced.

U.S. Pat. No. 1,890,180 disclosed a process of preventing the crystallization of honey in a compound of honey and peanut butter containing its normal oil consisting in adding to the compound approximately 12% by weight of green peanut oil.

U.S. Pat. No. 1,416,387 disclosed a peanut butter product comprising a mixture of sugar and peanut butter which have been mixed together by boiling and allowed to crystallize, wherein the crystallized sugar and peanut butter are of a consistency which will readily liquefy in substantially one part of water two parts of the product.

U.S. Pat. No. 3,044,883 disclosed a peanut spread which is shape-retaining, i.e. which can be made in the form of bars or the like and which holds its shape even in warm weather, while also being spreadable just after removal from the refrigerator.

U.S. Pat. No. 3,619,207 disclosed a process for improving the peanut paste ingredient by homogenizing.

U.S. Pat. No. 4,004,037 disclosed a process to improve stability and flavor by grinding peanuts in the presence of solid carbon dioxide to reduce oxidation of the peanut oil during the manufacturing process.

Nut butters typically contain high amounts of natural fat. For example, peanuts are comprised of approximately 50% fat. In addition to the naturally occurring fat in peanuts, total fat content are increased by adding hydrogenated fats, used as stabilizers in the above production process.

U.S. Pat. No. 5,230,919 (Walling et al.) shows a reduced fat nut or oilseed butter composition, which contains from 40% to 70% nut solids, from 33% to 45% oil, and from 0 to approximately 4% stabilizer, 40% bulking agent, 8% flavorant and 3% emulsifier.

U.S. Pat. No. 5,942,275 (Wong et al.) describes methodology for producing milk chocolate flavored nut spreads, and containing 30% to 60% total fat, from 10%-40% nut solids, from 15%- to 50% sugar, from 0.25% to 3% stabilizer, and from 0.01 % to 5% emulsifiers.

The relatively new, lower-fat peanut butters have accomplished little in improving nutritional values by eliminating about 25% of total fat, but replacing it with bulking agents and/or carbohydrates and generally reducing the flavor profiles of the reduced fat products.

It is therefore desired for a new process for manufacturing a lower-fat peanut butters and peanut butter spreads.

It is further desired that the peanut butters and/or peanut butter spreads created by the new process should keep the purest flavor of peanut butter by eliminating the emulsifying process.

It is still further desired that such process should eliminate the addition of stabilizers while exhibit minimal oil separation.

All percentages and parts expressed below are on a weight/weight basis unless otherwise specified.

### SUMMARY OF THE INVENTION

Peanut butters and peanut butters spreads with lower fat content, minimal oil separation, long shelf life and having desired sensory, textural and flavor characteristics are produced by (a) roasting peanuts to a specific degree and color; (b) grinding the roasted, unblanched peanuts to a particle size ranging from 1.5 to 3.5 mm; (c) if desired, adding specific herbs, spices, dried fruits and/or extracts of same, together with salt and/or sugar to the thus obtained peanut paste and blending all components at specific temperatures; (d) pumping the resultant peanut butter through specific pumping systems to depositors; and (e) feeding into containers and sealing.

One object of the invention is to produce a lower fat, true peanut butter (90% or higher peanut content) with other flavors, and a peanut butter spread (65% or higher peanut content) with other flavors, without an emulsification process.

Another object of the invention is to provide a further improvement in the production of natural peanut butters and peanut butter spreads, by greatly reducing the amount of oil separation and in the desired final product qualities in the absence of hydrogenated fats, stabilizers, bulking agents and emulsifiers.

In one preferred embodiment of the invention, a process for producing peanut butter and spiced and/or flavored peanut butter is disclosed. The process comprises of the following steps:
roasting peanuts at 350° F. to a dark color;
introducing the whole, unblanched peanuts into a mill capable of grinding the peanuts to a specific particle size; and
grinding the dark roasted unblanched peanuts to a coarse paste with a particle size range from 1.5 to 3.5 mm.

The process eliminates the use of stabilizers and an emulsification process, and the peanut butter and/or peanut butter spread manufactured by the above process are with lower fat content, exhibiting good spreadability and resistance to oil separation.

### BRIEF DESCRIPTION OF THE DRAWINGS

FIG. 1 is a flow diagram illustrating a process for producing peanut butter and spiced and/or flavored peanut butter according to one preferred embodiment of the invention; and

FIG. 2 is a flow diagram a preferred process for mixing and blending peanut butter.

### DETAILED DESCRIPTION OF THE INVENTION

The term “peanut butter” in particular as used herein is intended to include any peanut butters (21 C.F.R. 164.150) and peanut butter spreads (21 C.F.R. 102.23) and are not meant to be limited in any manner by regulatory definitions.

Peanut butter is normally available in two forms: a creamy style and a creamy base with diced peanut pieces or chunk nuts mixed therein; the latter being commonly referred to as chunk style or crunchy peanut butter. The conventional process for making creamy or chunky peanut butter comprises of several steps: roasting the shelled peanuts, cooling and blanching the roasted peanuts, finely grinding the peanuts, mixing into the ground peanut paste (optional) salt and/or sugar, adding a hydrogenated component (hard fat) to the mixture, and regrinding the mixture and/or emulsifying the mixture through several available methods. Chunky or crunchy style peanut butter production adds diced or granulated chunks to the above obtained mixture prior to packaging.

A distinction is made for the class of peanut butters, commonly referred to as natural peanut buffers, which are also available in the above-mentioned creamy and chunky style, wherein the term “natural” refers to its process of processing peanuts without adding hydrogenated fats as stabilizers, or emulsifiers into the mixture. The resulting peanut butter has superior flavor attributes compared to the emulsified peanut butters, but exhibits gravitational instability, i.e., oil separation on the top of the product.

In typical creamy or chunky peanut butter formulations, the peanuts in their various forms are combined with stabilizers, and at the producer's option, emulsifiers, sweeteners and salt. Stabilizers are usually present in amounts ranging from 0.5% to 2.5% by weight of the final product. Typical stabilizers include partially or fully hydrogenated oils such as rapeseed, cottonseed, corn, soybean, linseed or palm. Emulsifiers, if added, usually represent from about 0.1-1% by weight of the final product, include lecithin, monoglycerides, glycerine, and propylene glycol among others. Salt is typically added as a flavoring agent in amounts ranging from 0-2% by weight. Sweeteners may include sugar, honey, molasses, sucrose, dextrose or fructose, among others, in amounts ranging from 0-8% by weight.

Typical recipes for regular peanut butter are as follows:

| Ingredients | % of total |
|---|---|
| Peanuts, peanut slurry, peanut oil or defatted peanut flour | 90-96% |
| Seasonings - salt, sugar, honey, etc. | 1-9% |
| Stabilizer | 0.5-2.5% |
| Emulsifiers | 0-1% |

Reduced fat peanut butters or peanut butter spreads typically will replace peanuts and/or the naturally present peanut oil with bulking agents, which include corn syrup solids, microcrystalline cellulose, polydextrose, maltodextrin, and other carbohydrates and combinations thereof. Bulking agents may represent up to 50% of the weight of the final product.

Typical recipes for reduced fat peanut butter and peanut butter spread are as follows:

| Ingredients | % of total |
|---|---|
| Peanuts, peanut slurry, peanut oil or defatted peanut flour | 25-70% |
| Seasonings - salt, sugar, honey, etc. | 0-10% |
| Stabilizer | 0.3-2% |
| Emulsifiers | 0-1% |
| Bulking agents | 10-50% |

The present invention provides a new process for manufacturing a natural peanut butter, spiced and/or flavored peanut butters and peanut butter spreads, exhibiting very low oil separation, long shelf life, good spreadability and texture, and having lower fat content without the use of stabilizers, emulsifiers, bulking agents and without utilizing an emulsification process.

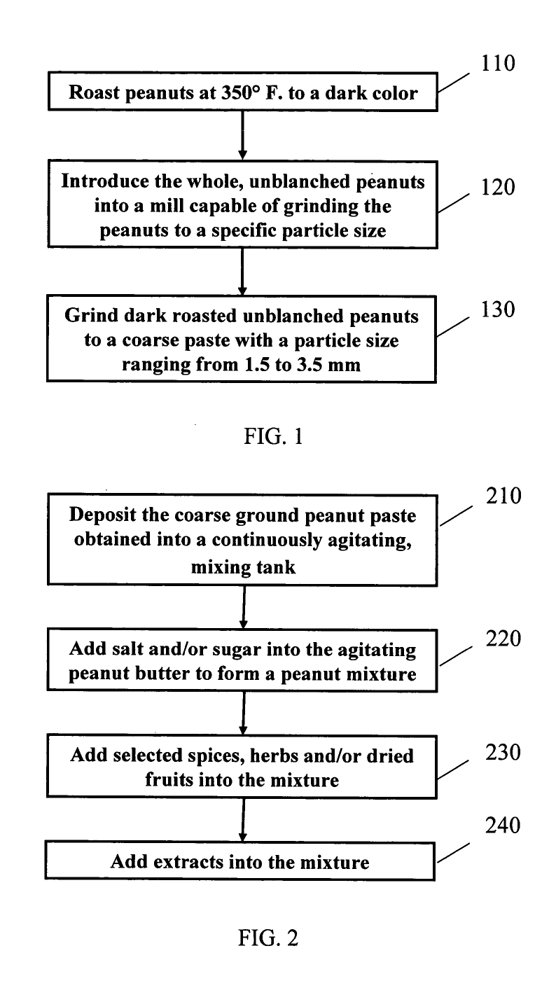

FIG. 1 is a flow diagram illustrating a process for producing peanut butter and spiced and/or flavored peanut butter according to one preferred embodiment of the invention. The process comprises the following steps:
Step 110: Roast peanuts at 350° F. to a dark color;
Step 120: Introduce the whole, unblanched peanuts into a mill capable of grinding the peanuts to a specific particle size; and
Step 130: Grind the dark roasted unblanched peanuts to a coarse paste with a particle size range from 1.5 to 3.5 mm.

The dark color in the roasting step is typically USDA color 4, or slightly above.

Optimum product results were obtained in an 18″ Cantrell Mill, set to yield 3.0-3.5 mm grind. Alternately, when the desired flavor profiles demanded a finer grind, the Urschell Laboratories Comitrol Mill, fitted with a 190 micro cut head, produced the planned 1.5-2.0 mm grind.

The process of grinding produces friction and therefore, heat. The coarse peanut butter produced typically has a temperature within the range from 145° to 165° F. Preferably, additional steps for mixing and blending peanut follow immediately after the grinding process.

FIG. 2 is a flow diagram a preferred process for mixing and blending peanut butter. During this process, various spices, herbs, dried fruits and/or extracts of it, salt, and/or sugar will be mixed and blended in the peanut paste from the above grinding step. The process for mixing and blending peanut typically includes of the following steps:
Step 210: Deposit the coarse ground, warm-to-hot peanut paste obtained by the above process, into a continuously agitating, mixing tank;
Step 220: Add salt and/or sugar into the agitating peanut butter to form a peanut mixture.

Optionally, the process may further include the step of:
Step 230: Add selected spices, herbs and/or dried fruits into the mixture.

The process may also further include the step of:
Step 240: Add extracts into the mixture.

The time period for mixing and blending the peanut butter ranges between 5-15 minutes, during which the peanut butter, or the spiced/flavored peanut butter or peanut butter spread cools to a temperature between 120° and 125° F., and is under constant agitation. At the time when the thus produced peanut butter reaches the optimum temperature ranging from 120° to 125° F., the mixture is pumped through two successive Viking PD pumps, set at close tolerances, into a depositing system, and deposited into containers.

In summary, the present invention describes a specific roasting process in combination with a specific grinding process. Selected peanuts are roasted to a USDA color 4, or slightly above, reducing the water content of the peanuts above that of conventional roasting processes. Dark roasted peanuts are then ground to a coarse consistency, releasing minimum amounts of the natural peanut oil, in direct contrast with conventional processes of grinding, where the goal of the processes is to release the maximum amount of peanut oil.

The process according to the present invention further provides for the full use of the naturally occurring skin of peanuts. The fat content of peanut skin in red skinned peanuts is about 11.70%; and compared to the fat content of peanuts at around 50%, is quite low. In typical peanut butter processes, the skins are removed and discarded prior to grinding. By incorporating the whole peanut, including the skin, into the manufacturing process, the overall fat content is significantly reduced. Additionally, the peanut skin eliminates the use of additives such as bulking agents, when combined with the roasting and grinding methods described.

The process according to the present invention thus results in a peanut butter in its purest form, but with less fat and minimal released peanut oil. This peanut butter base provides the ideal medium for the incorporation of spices, flavors, herbs, dried fruits and extracts thereof, and sugar and/or salt.

The process according to the present invention eliminates the addition of stabilizers and the utilization of an emulsification process. The resultant peanut butter, spiced and/or flavored peanut butter or peanut butter spread is lower in fat, exhibits minimal oil separation, and does not contain any stabilizers.

Furthermore, the process has eliminated the added process of emulsification.

The following examples illustrate typical ingredients of peanut butters manufactured by the process according to the present invention. The examples are illustrative in nature and do not limit the invention thereto.

### EXAMPLE 1

In this example, the peanut butter manufactured by the process described above contains 99.18% of peanuts and 0.82% of salt. The ingredients of this peanut butter are listed below:

| Ingredients | % of total |
|---|---|
| Peanuts | 99.18% |
| Salt | 0.82% |

### EXAMPLE 2

In this example, the peanut butter manufactured by the process described above contains 93.02% of peanuts, 6.57% of seasonings, and 0.41% of herbs. The seasonings may include salt and/or spices. The ingredients of this peanut butter are listed below:

| Ingredients | % of total |
|---|---|
| Peanuts | 93.02% |
| Seasonings - salt, spices | 6.57% |
| Herbs | 0.41% |

### EXAMPLE 3

In this example, the peanut butter manufactured by the process described above contains 90% of peanuts, and 10% of seasonings. The seasonings may include sugar, salt and/or spices. The ingredients of this peanut butter are listed below:

| Ingredients | % of total |
|---|---|
| Peanuts | 90.00% |
| Seasonings - sugar, salt, spices, etc. | 10.00% |

### EXAMPLE 4

In this example, the peanut butter spread manufactured by the process described above contains 86.7% of peanuts, and 13.3% of seasonings. The seasonings may include sugar and/or natural flavor. The ingredients of this peanut butter are listed below:

| Ingredients | % of total |
|---|---|
| Peanuts | 86.70% |
| Seasonings - sugar, natural flavor | 13.30% |

### EXAMPLE 5

In this example, the peanut butter spread manufactured by the process described above contains 79.6% of peanuts, 10.55% of seasonings, and 9.85% of dried fruit. The seasonings may include sugar and/or natural flavor. The ingredients of this peanut butter are listed below:

| Ingredients | % of total |
|---|---|
| Peanuts | 79.60% |
| Seasonings - sugar, natural flavor | 10.55% |
| Dried Fruit | 9.85% |

Although the invention is described herein with reference to the preferred embodiment, one skilled in the art will readily appreciate that other applications may be substituted for those set forth herein without departing from the spirit and scope of the present invention.

Accordingly, the invention should only be limited by the Claims included below.

1. A process for producing peanut butter and spiced and/or flavored peanut butter, with lower fat content, exhibiting good spreadability and resistance to oil separation, without the use of stabilizers and an emulsification process, comprising the steps of:
roasting peanuts at 350° F. to a dark color;
introducing the whole, unblanched peanuts into a mill capable of grinding the peanuts to a specific particle size; and
grinding the dark roasted unblanched peanuts to a coarse paste with a particle size ranging from 1.5 to 3.5 mm.

2. The process of claim 1, wherein said dark color is typically USDA color 4, or slightly above.

3. The process of claim 1, wherein said coarse peanut paste has a particle size ranging from 3.0 to 3.5 mm.

4. The process of claim 1, wherein said coarse peanut paste has a particle size ranging from 1.5 to 2.0 mm.

5. The process of claim 1, wherein said specific spices, herbs, dried fruits and/or extracts of same, salt and/or sugar are blended with the peanut paste produced in said grinding step.

6. The process of claim 1, wherein, immediately after said grinding step, said coarse peanut paste has a temperature ranging from 145° to 165° F.

7. The process of claim 1, further comprising the following steps for mixing and blending peanut butter:
depositing said coarse peanut paste into a continuously agitating, mixing bank; and
adding salt and/or sugar into said bank to form a peanut mixture.

8. The process of claim 7, further comprising the step of:
adding selected spices, herbs and/or dried fruits into said peanut mixture.

9. The process of claim 8, further comprising the step of:
adding extracts into said peanut mixture.

10. The process of claim 7, further comprising the steps of:
adding selected spices, herbs and/or dried fruits into said peanut mixture; and
adding extracts into said peanut mixture.

11. The process of claim 7, wherein said step for mixing and blending peanut butter typically takes 5 to 15 minutes.

12. The process of claim 11, wherein, immediately after said step for mixing and blending peanut butter, said peanut mixture has a temperature ranging from 120° to 125° F.

13. The process of claim 12 further comprising the step of:
pumping said peanut mixture into a depositing system and depositing said peanut butter mixture into a plurality of containers.

14. A peanut butter or peanut butter spread manufactured with a process comprising the steps of:
roasting peanuts at 350° F. to a dark color;
introducing the whole, unblanched peanuts into a mill capable of grinding the peanuts to a specific particle size; and
grinding said dark roasted unblanched peanuts to a coarse paste with a particle size ranging from 1.5 to 3.5 mm.

15. The peanut butter or peanut butter spread of claim 14, wherein said dark color is USDA color 4, or slightly above.

16. The peanut butter or peanut butter spread of claim 14, wherein said coarse peanut paste has a particle size ranging from 3.0 to 3.5 mm.

17. The peanut butter or peanut butter spread of claim 14, wherein said coarse peanut paste has a particle size ranging from 1.5 to 2.0 mm.

18. The peanut butter or peanut butter spread of claim 14, wherein specific spices, herbs, dried fruits and/or extracts of same, salt and/or sugar are blended with the peanut paste produced in said grinding step.
